(19) United States
(12) Patent Application Publication
(10) Pub. No.: US 2014/0168263 A1
(43) Pub. Date: Jun. 19, 2014

(54) CONSUMER ELECTRONICS WITH AN INVISIBLE APPEARANCE

(71) Applicants: UYGAR E. AVCI, Portland, OR (US); ISLAM A. SALAMA, Chandler, AZ (US); RASEONG KIM, Hillsboro, OR (US)

(72) Inventors: UYGAR E. AVCI, Portland, OR (US); ISLAM A. SALAMA, Chandler, AZ (US); RASEONG KIM, Hillsboro, OR (US)

(21) Appl. No.: 13/720,062

(22) Filed: Dec. 19, 2012

(51) Int. Cl. G06T 11/60

(52) U.S. Cl. CPC G06T 11/60
USPC 345/633

(57) ABSTRACT

A method, electronic device and system for displaying background images on an electronic device, wherein the electronic device includes a face that has at least one edge and a display visible in the face. The display extends to at least one edge of the face. Furthermore, a processor is coupled to the display and a photosensor is coupled to the processor. The photosensor is configured to capture background images of a background obscured behind the device when viewing the device face. The processor is configured to composite the background image with a second image.

### FIELD

The present disclosure relates to consumer electronics that provide an invisible or camouflaged appearance, such that the device is configured to display the background obscured behind the device when viewing the device and methods thereof.

### BACKGROUND

Consumer devices, such as cell phones, televisions, computer monitors, etc., are ubiquitous. These devices are typically quite visible in the surrounding environment and often block the view of the environment behind them. Take, for example, the case of cell phones. Often cell phone users hold their phone up to view the screen, while walking or performing other tasks. However, this blocks the view of the environment behind the phone, such as the side walk, the busy street or children playing at the park. Or consider a television screen, which generally blocks the view of everything behind it, such as a wall or the other side of a room. While efforts have been made to reduce the foot print of some of these consumer devices, in the case of televisions for example, larger screens are commonly more desirable. Accordingly, there remains room for improvement in blending consumer devices into the environment, or at least, allowing the user to see the environment behind the device.

### BRIEF DESCRIPTION OF THE DRAWINGS

The above-mentioned and other features of this disclosure, and the manner of attaining them, may become more apparent and better understood by reference to the following description of embodiments described herein taken in conjunction with the accompanying drawings, wherein:

FIG. 1 illustrates a schematic of an embodiment of a mobile device and the background obscured behind the device when viewing the device face;

FIG. 2 illustrates a schematic view of an embodiment of a mobile device and the background behind the device is visible in the device face;

FIG. 3 illustrates a schematic front view of an embodiment of a mobile device;

FIG. 4 illustrates a schematic rear view of an embodiment of a mobile device;

FIG. 5 illustrates a schematic diagram of an embodiment of a system for displaying a background obscured behind the device when viewing the device face;

FIG. 6 illustrates an embodiment of an embodiment of a method of displaying a background on the face of a mobile device;

FIG. 7 illustrates a schematic of an embodiment of a mobile device; and

FIG. 8 illustrates a schematic device of an embodiment of a mobile device.

### DETAILED DESCRIPTION

As noted above, current mobile devices generally provide an opaque view to the user, obscuring the background behind the device and preventing the user from viewing what is behind the device. Devices may appear out of place and feel less natural the user as compare to a device blended relatively more into the environment. It is also common for users to use their devices in crowded urban areas to answer calls, look up maps, etc., while standing or walking in a crowd. This makes a user more vulnerable for accidents, reducing the user's safety and increases the possibility that a user's device is broken. While this disclosure refers, in particular to mobile device, the subject matter described herein is equally applicable to other devices, such as televisions, computer screens, laptops, etc.

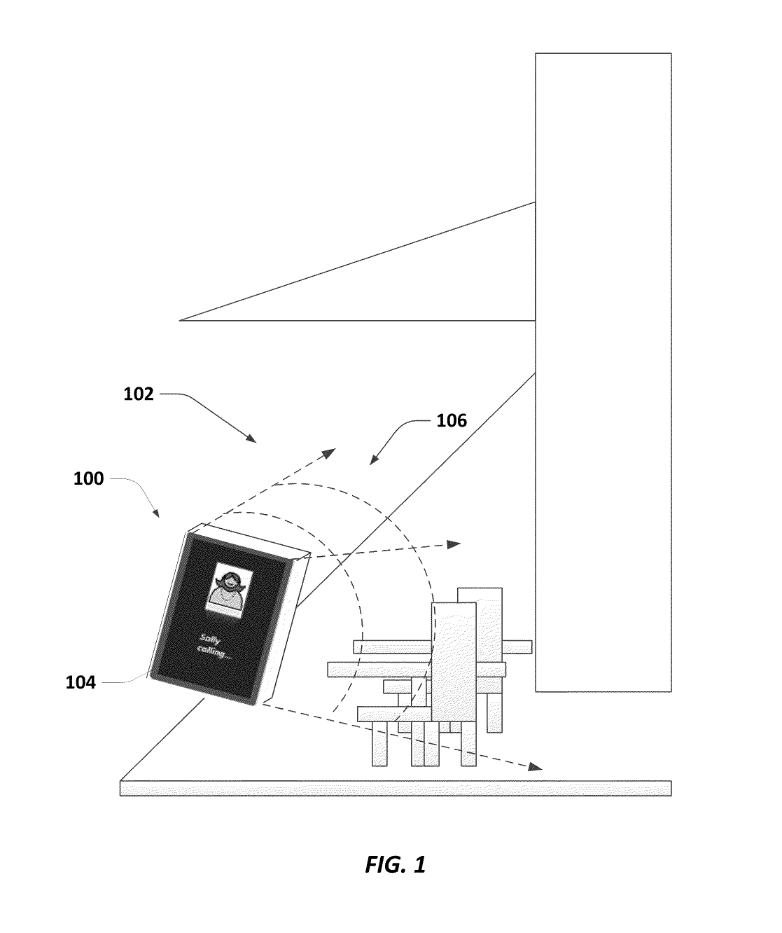

FIG. 1 illustrates a mobile device 100, i.e., any device that is portable and provides data communication, such as a mobile phone or tablet, as used when walking across a street 102. When viewing the face 104 of the mobile device 100, the user's view of the background 106, i.e., the street, tables, chair, etc. becomes obscured. That is, the user's view is either blocked or made unclear due to the user's focus on the face 104 of the mobile device 100. Accordingly, provided herein is an electronic device, method and system of displaying the background on the face of the device while viewing other images on the device. The device, system and method herein aids in blending the device into the environment and, particularly in the case of mobile devices, improves safety.

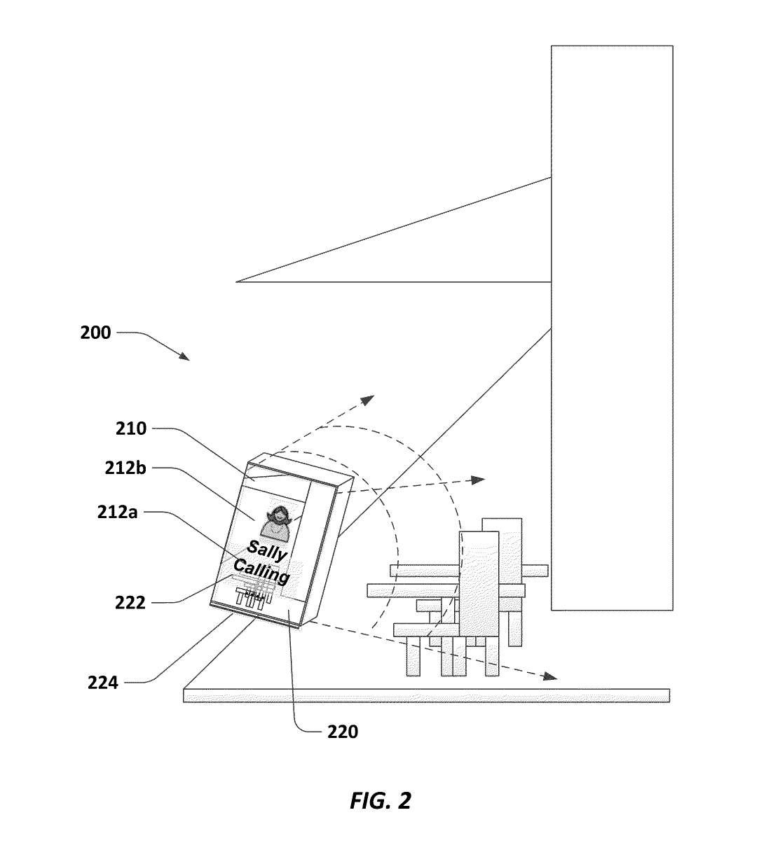

FIG. 2 illustrates an embodiment of an electronic device 200, which as illustrated is a mobile phone. As seen in the figures, the mobile device 200 includes a display 220 on the face 222 of the device. The device displays images of the background 210 and two second images 212a, 212b, such as an application image “over” the background image 210. The second image has varying degrees of translucency, from 0% translucent, i.e. opaque, to 100% translucent, i.e.

transparent, including all values and ranges therein, such as 25%, 50%, 75%, etc. As illustrated the upper second image 212a is opaque, completely covering the underlying image, and the lower second image 212b is 50% translucent, such that some of the background image 210 is visible. In addition, as illustrated in FIG. 2, the display 220 is coextensive with the device face, i.e., extending across the device face to all of the edges 224 of the device face. Alternatively, the display 220 extends to less than all of the edges 224 of the face and up to only one edge 224 of the face 222 of the device 200.

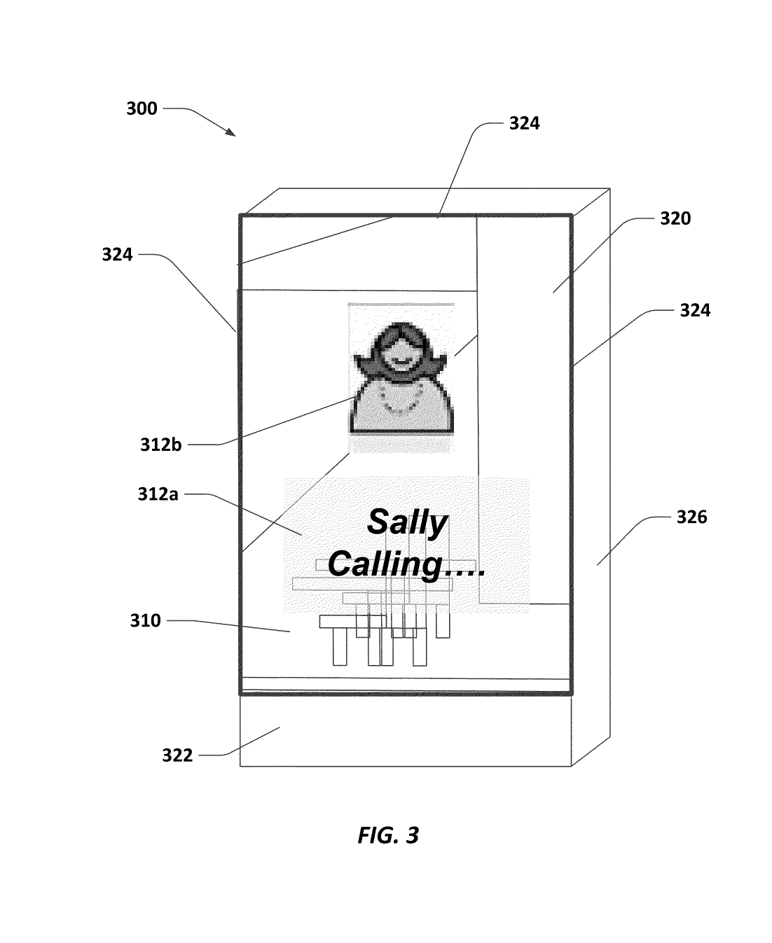

FIG. 3 illustrates an embodiment, where the display 320 extends to three edges 324 of the face 322 of the device 300. Again, the device is displaying a background image 310 and two second images 312a, 312b, which appear “over” the background image 310. As understood, the higher the degree the display is coextensive with the face, greater the benefit. Furthermore, a transparent frame 326 is provided around the periphery of the display at the edges of the display and electronic device and forming part of the packaging or body of the electronic device. Transparent is understood as allowing at least 50% of incident light to pass through, such as in the range of 50% to 100%, including all values and ranges therein.

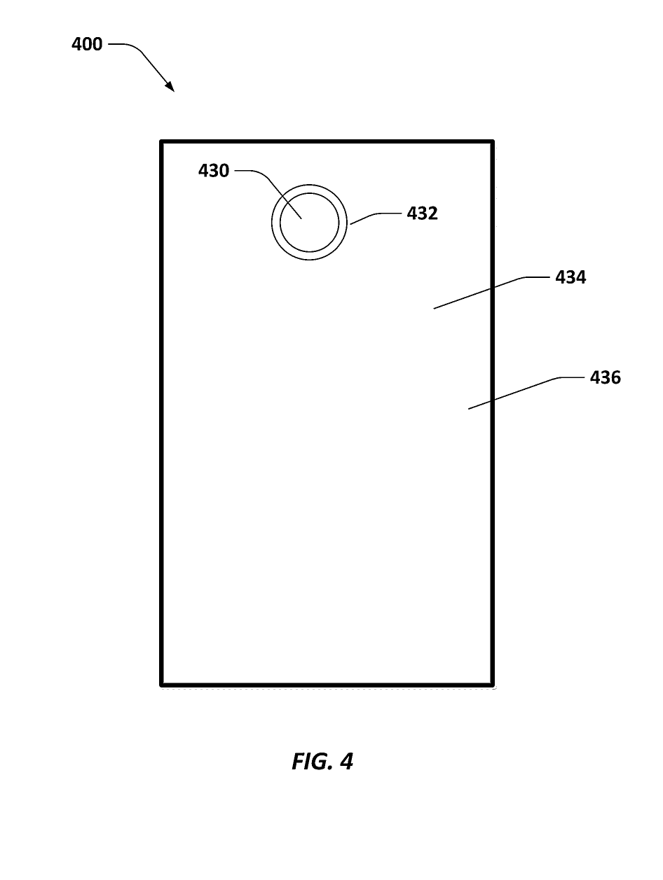

In embodiments, as illustrated in FIG. 4, the images are acquired with a photosensor 430 configured to capture images through an opening 432 formed in the rear face 434, i.e., the face on the opposing side of the electronic device 400 from the display. In embodiments, multiple photosensors are employed, from one photosensor to ten photosensors, including all values and ranges therein, such as 1, 2 or 3. As may be appreciated a relatively higher quality image may be achieved if the device has additional photosensors.

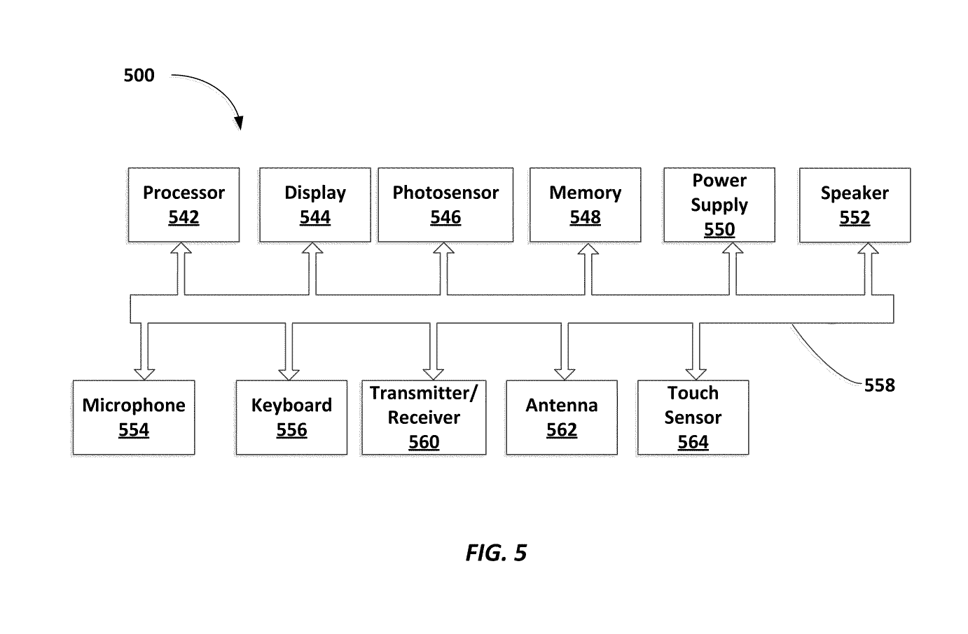

In an embodiment, the device 500 employs a system 540 for forming and displaying the images, illustrated in FIG. 5. The system 540 generally includes a processor 542, a display 544, a photosensors 546, memory 548, a power supply 550, as well as optionally, various user interfaces, such as a speaker 552, microphone 554, keyboard 556, battery and various I/O components, etc. The various components are connected via a system bus 558. The system bus is selected from, for example, a local bus, a peripheral bus, a memory bus or memory controller, using any variety of bus structures. While a single, central bus is illustrated, other alternative bus designs, including multiple busses can be utilized. In addition, in embodiments, a transceiver, receiver, transmitter or combinations thereof (collectively 560) is present and configured to provide communication via various communication protocols and standards, such as BLUETOOTH®, WI-FI® IEEE 802.11, Global System for Mobile Communications (GSM), Interim Standard 95, CDMA2000, LTE Advanced, etc. Furthermore, an antenna is present 562.

The processor 542 includes one or more processors. The processor includes, for example, a CPU, programmable circuitry, microprocessor, etc. In embodiments, the processors are dedicated to specific tasks, such as a graphic processor, a video processor, an image processor, a communication or baseband processor, an application processor etc. Additionally, in embodiments processing is accomplished, shared, or distributed between one or more processors. For example, an application processor may manage not only applications, but also BLUETOOTH and WI-FI communications. In embodiments, a codec is also provided for encoding and decoding digital data streams or signals. A codec may be integrated into one or more of the processors or may be stand alone. For example, a codec may be provided on the video processor, application processor or communication processor. As described further below, the processor(s) are configured to perform a number of functions, including compositing of the background images captured with the photosensor with a second image, such as those generated by various applications running on the device.

As alluded to above, one or more displays are present on one or more faces of the device and extends to at least one edge of the device face. In embodiments, the display is coupled to one or more processors, such as a graphics processor, either directly or through the system bus as illustrated in FIG. 5. In embodiments, the display is a light emitting diode (LED) display, such as an organic LED display, or a liquid crystal display. The pixel density is in the range of 100 pixels per inch to 1000 pixels per inch, including all values and ranges therein. In embodiments, a portion of the display is touch sensitive including a touch sensor 564 such as a capacitance sensor, resistive sensor, surface acoustic wave sensor, infrared sensor, etc.

Memory 548 includes read only memory (ROM) and random access memory (RAM) in the form of one or more memory structures are present in the system. Memory structures include, for example, NAND, SRAM, SDRAM, etc. In embodiments, memory is used to store the operating system, various applications, application framework or middleware, optional program modules, etc. Memory is also used as a buffer to store the capture image data prior to processing, after processing, and prior to being displayed, such as in a frame buffer.

One or more photosensors 546 are provided to capture images, including images of the background that is obscured when a user utilizes the electronic device as described above in FIGS. 1 and 2. The photosensor 546 includes, for example, either a complimentary metal-oxide semiconductor (CMOS) or an active pixel sensor, or a charge coupled device (CCD). The photosensor is coupled either directly or through the serial bus to a processor, which manipulates the image, stores the images in memory, etc. As noted above, the photosensor is configured, or positioned such that it is capable of capturing images of the background behind the face of the electronic device being viewed. For example, as described above with reference to FIG. 4, the photosensor 430 is exposed through an opening 432 in the face 434 of the body 436 of the electronic device 400 opposite the face that includes the display viewed by the user. In embodiments, a flash, shutter, or both are provided.

The power supply includes, for example, one or more of a battery, a photovoltaic cell or a power supply cable as well as corresponding interfaces. Additionally, in embodiments, various transformers, alternating current to digital current converters, and other power management devices as well as, optionally, a power management processor are provided.

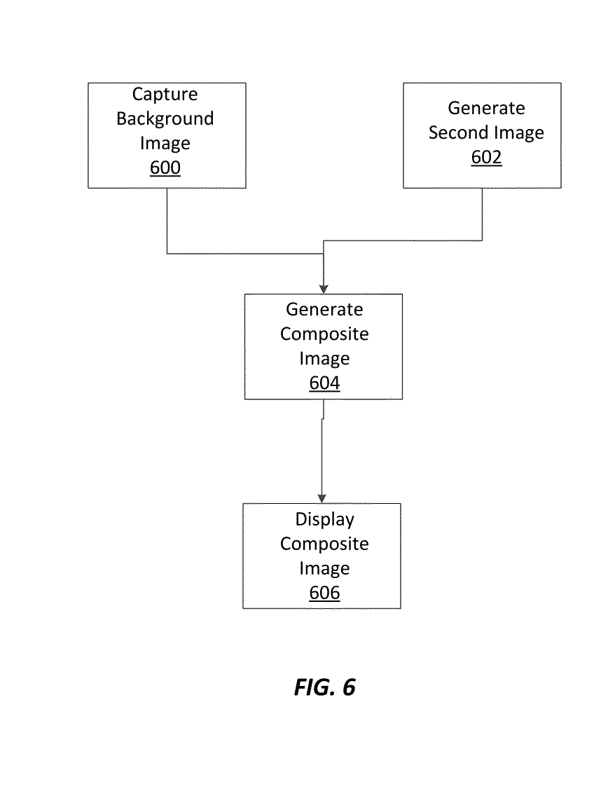

In embodiments, a method of displaying captured background images on the display of an electronic device that is being viewed by a user is performed by the system above. As illustrated in FIG. 6, background images are captured with the photosensor 600. The background images include still pictures or video of the background behind the electronic device as viewed from the vantage point of the user, but at least partially obscured due to the electronic device. In addition, one or more applications generate a second image 602 that includes one or more of graphics, video, text or other types of images. The images are composed of various forms of data, translated into pixels and shown on the display.

In embodiments, the background image and second image are composited into a single composited image to be displayed 604. Compositing is understood as a process in which the background and second image are arranged together to form the single image. Compositing is performed using a processor (or one or more processors), which uses instructions for forming the composited image from one or more applications stored in memory. The composited image is then displayed 606 on the display.

In embodiments, compositing is performed utilizing alpha blending, wherein a translucency value from 0% to 100% is selected for each pixel forming the foreground, or overlying image, and the inverse of the translucency value is selected for each pixel forming the background image. A value of 0% indicates that the overlying image pixel is transparent (showing only the underlying image pixel) and a value of 100% indicates that the overlying image is opaque (and the underlying image pixel is not visible at all). While, as discussed herein the secondary image is assumed to be the overlying or foreground image, the background image forms the overlying image in embodiments as well. As a translucency value is selected on a pixel by pixel basis, the second image is divided into segments, wherein segments are selected by the application generating the second image or the application performing the compositing to appear translucent, transparent (i.e., not appear at all) or appear opaque, such as the opaque image 212a and the translucent image 212b illustrated in FIG. 2. In such a manner, portions of the second image, generated by the application data, appear to overlay the background image. In further embodiments, the application or software designer can control the desired transparency of the displayed image. In addition, or alternatively, the user inputs a desired transparency level of the secondary image.

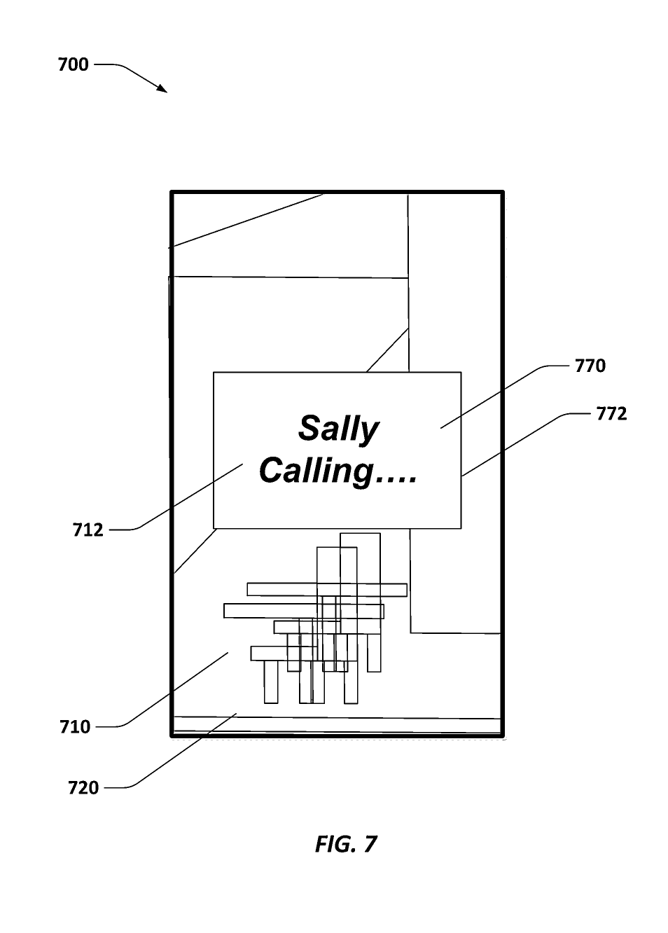

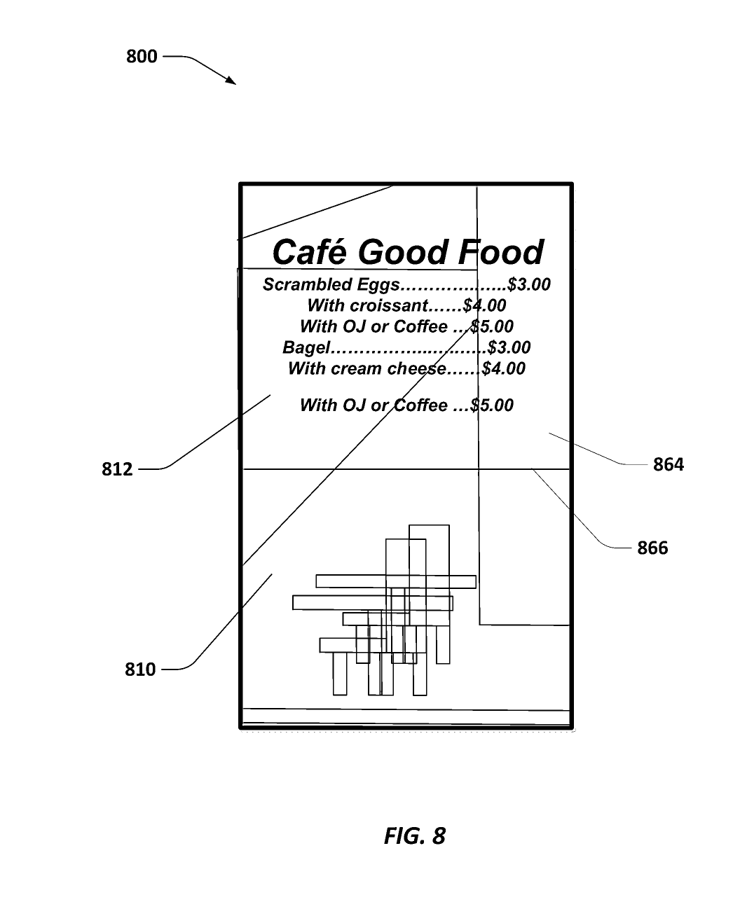

In embodiments, the second image is isolated to certain portions of the display. In examples, the second image is displayed as blocks. For example, and referring to FIG. 7, the second image 712 is placed in the center of the display 720 on the device 700 and the background image 710 frames the periphery 772 of the second image. While portions of the background image may be blocked, the display still provides a reference as to what is occurring in the background behind the electronic device. In other embodiments, as illustrated in FIG. 8, the second image 812, the menu text, appears to overly the background image 810, wherein only the text or limited portions of the secondary image are opaque or exhibit a translucency value of greater than, for example, 50% and the background image is otherwise visible. In embodiments, the designer of the applications or software controls the definition of the areas that are blocked or that show the background image. In addition to, or alternatively, other processing methods, are selected for compositing the images as known in the art. In further embodiments, the touch sensitive portion of the screen is isolated to areas where the second image is present. Alternatively, or in addition, the second image is isolated to areas where the touch screen is present on the display. Thus, as illustrated in FIG. 8, the touch screen 864 of the device 800 is encompassed by the same boundaries 866 as the second image 812.

Further, any of the operations described herein may be implemented in a system that as alluded to above includes one or more tangible storage mediums having stored thereon, individually or in combination, instructions that when executed by one or more processors perform the methods. Here, the processor may include, for example, a system CPU and/or other programmable circuitry. Also, it is intended that operations described herein may be distributed across a plurality of physical devices, such as processing structures at more than one different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

Again, the electronic device is one of a number of electronic devices, such as a mobile phone or tablet, a television, computer display or other display screens that may be employed for various purposes, including those in appliances (refrigerators or dishwashers), etc. The above allows a user to see the object of interest on a screen and the background environment in the display. In addition, the above may camouflage or render relatively invisible the appearance of the device, blending it into the background. Accordingly, the visual user experience may be relatively improved by adapting the electronic device to the environment and making the environment appear less bulky. In addition, such technology may result in an improvement in safety, allowing the user to see the background and anticipate as well as avoid accidents. Also, the user can have a simple transparency control button, like a volume button existing in remote controls today, that changes transparency ratio, all the way from 0% (opaque) to 100% (fully transparent).

Accordingly, in one aspect the present disclosure relates to an electronic device. The electronic device includes a face, the face having at least one edge and a display visible in the face wherein the display extends to the at least one edge. The device also includes a processor coupled to the display and a photosensor in coupled to the processor. The photosensor is configured to capture background images of a background obscured behind the device when viewing the face. The processor is configured to composite the background image with a second image.

In the above embodiment, the second image is selected from the group consisting of a graphic image, a video image or combinations thereof. In addition, in any of the above embodiments, the processor is configured to display second image translucently over the background image. Further, in any of the above embodiments, the processor is configured to form the composite image using alpha blending. Also, in any of the above embodiments, the second image includes a periphery and the processor is configured to display the background image around the periphery of the second image.

In any of the above embodiments, the display includes a touch sensitive portion and the processor is configured to display the second image in the touch sensitive portion. In addition, in any of the above embodiments, the display is coextensive with said face. Further, in any of the above embodiments, the face includes a periphery formed of one or more edges and the device further includes a transparent frame positioned around the periphery.

In addition, in any of the above embodiments, the device is a mobile phone. Further, in any of the above embodiments, the device is a television.

Another aspect of the present disclosure relates to a method of displaying background images on a device. The method includes capturing background images with a photosensor coupled to a processor, wherein the device has a face and the background images are of a background obscured when viewing the face of the device. The method also includes compositing the background image and a second image forming a composited image. In addition, the method includes displaying the composited image on a display coupled to the processor, wherein the display extends to at least one edge of the face.

In the above embodiment, the display is coextensive with the face. In any of the above embodiments compositing is performed using alpha blending. In addition, in any of the above embodiments, the second image is translucent and appears on top of the background image in the composited image. In any of the above embodiments, the background images and the second images are displayed as blocks on the display in the composited image. In any of the above embodiments, the background image is displayed around the periphery of said second image in said composited image. In any of the above embodiments, the second image is generated from application software.

Yet another aspect of the present disclosure relates to a system comprising, one or more storage mediums having stored thereon, individually or in combination, instructions that when executed by one or more processors result in the following operations including: capturing background images of a background obscured by the system using a photosensor coupled to a processor, compositing the background images and a second image creating a composited image, and displaying the composited image on a display coupled to the processor, wherein the display extends to at least one edge of a device face.

In the above embodiment, the instructions that when executed by one or more of the processors result in the following additional operation of overlaying the second image over the background image. In any of the above embodiments, compositing is performed using alpha blending. In any of the above embodiments, a portion of said background images and the second images are displayed as blocks in the composited image. Further, in any of the above embodiments, a portion of the background image is displayed around the periphery of the second image. In addition, in any of the above embodiments, the instructions that when executed by one or more of the processor result in the following additional operations comprising generating the second image from application software.

What is claimed is:

1. An electronic device comprising:
a face, said face having at least one edge;
a display visible in said face wherein said display extends to said at least one edge;
a processor coupled to said display; and
a photosensor in coupled to said processor, wherein said photosensor is configured to capture background images of a background obscured behind said device when viewing said face; and
wherein said processor is configured to composite said background image with a second image.

2. The device of claim 1, wherein said second image is selected from the group consisting of a graphic image, a video image or combinations thereof.

3. The device of claim 1, wherein said processor is configured to display second image translucently over said background image.

4. The device of claim 1, wherein said processor is configured to form said composite image using alpha blending.

5. The device of claim 1, wherein said second image includes a periphery and said processor is configured to display said background image around said periphery of said second image.

6. The device of claim 1, wherein said display includes a touch sensitive portion and said processor is configured to display said second image in said touch sensitive portion.

7. The device of claim 1, wherein said display is coextensive with said face.

8. The device of claim 1, wherein said face includes a periphery formed of said one or more edges and said device further comprises a transparent frame positioned around said periphery.

9. The device of claim 1, wherein said device is a mobile phone.

10. The device of claim 1, wherein said device is a television.

11. A method of displaying background images on an electronic device, comprising:
capturing background images with a photosensor coupled to a processor, wherein said device has a face and said background images are of a background obscured when viewing the face of said device;
compositing said background image and a second image forming a composited image; and
displaying said composited image on a display coupled to said processor, wherein said display extends to at least one edge of said face.

12. The method of claim 11, wherein said display is coextensive with said face.

13. The method of claim 11, wherein said compositing is performed using alpha blending.

14. The method of claim 11, wherein said second image is translucent and appears on top of said background image in said composited image.

15. The method of claim 11, wherein said background images and said second images are displayed as blocks on said display in said composited image.

16. The method of claim 15, wherein said background image is displayed around the periphery of said second image in said composited image.

17. The method of claim 11, wherein said second image is generated from application software.

18. A system comprising, one or more storage mediums having stored thereon, individually or in combination, instructions that when executed by one or more processors result in the following operations comprising:
capturing background images of a background obscured by said system using a photosensor coupled to a processor;
compositing said background images and a second image creating a composited image; and
displaying said composited image on a display coupled to said processor, wherein said display extends to at least one edge of a device face.

19. The system of claim 18, wherein the instructions that when executed by one or more of the processors result in the following additional operations comprising overlaying said second image over said background image.

20. The system of claim 18, wherein said compositing is performed using alpha blending.

21. The system of claim 18, wherein a portion of said background images and said second images are displayed as blocks in said composited image.

22. The system of claim 18, wherein a portion of said background image is displayed around the periphery of said second image.

23. The system of claim 18, wherein the instructions that when executed by one or more of the processor result in the following additional operations comprising generating said second image from application software.
